(19) United States
(12) Patent Application Publication
(10) Pub. No.: US 2022/0295712 A1
(43) Pub. Date: Sep. 22, 2022

(54) INTERMITTENT CONTINUOUS LIGHT APPLICATION FOR THE INCREASE OF DRY MATTER PERCENTAGE IN FLOWER BUDS

(71) Applicant: SIGNIFY HOLDING B.V., EINDHOVEN (NL)

(72) Inventor: Celine Catherine Sarah NICOLE, EINDHOVEN (NL)

(21) Appl. No.: 17/617,454

(22) PCT Filed: Jun. 15, 2020
(86) PCT No.: PCT/EP2020/066472

§ 371 Date: Dec. 8, 2021

(30) Foreign Application Priority Data
Jun. 21, 2019 (EP) 19181728.7

(51) Int. Cl. A01G 7/04; A01G 22/00

(52) U.S. Cl. CPC A01G 7/045; A01G 22/00

(57) ABSTRACT

The invention provides a lighting method for providing light to a Cannabis plant during at least a flowering stage of the Cannabis plant, the method comprising: providing the horticulture light to the Cannabis plant during the flowering stage according to a flowering stage time scheme, wherein the flowering stage time scheme lasts n_{f} weeks and includes a flowering stage on-off schedule of the horticulture light wherein during each 24 hours the on-time is at least 10 hours and the off-time is at least 10 hours , except for k_{f} deviations from the flowering stage on-off schedule of the flowering stage time scheme, wherein each deviation includes an on-time selected from the range of 24-72 hours , wherein n_{f} is at least 6, and wherein k_{f} is selected from the range of 1≤k_{f}≤n_{f}.

### FIELD OF THE INVENTION

The invention relates to a lighting method for providing light to a Cannabis plant. The invention also relates to a method for growing a Cannabis plant for medicinal purposes. Yet further, the invention relates to a computer program product for executing such method(s). The invention also relates to a horticulture lighting system with which such method(s) may be executed.

### BACKGROUND OF THE INVENTION

Methods of growing Cannabis plants using artificial lighting are known in the art. US2016/0184237, for instance, describes a method of growing a cannabis or humulus plant, comprising exposing said plant to artificial light, irrigating said plant with water, and providing one or more nutrients; wherein exposing said plant to artificial light comprises: providing said artificial light at a different intensity level for plant growth phases of vegetative and flower growth; and said plants are exposed to about 125 micromoles to about 500 micromoles during the vegetative phase and from about 400 micromoles to about 975 micromoles during the flower phase of growth; and providing said artificial light to the plant from one or more different directions, which directions are the top, the sides, and the bottom of the plant; and optionally changing the relative positions of the plant to the artificial light by moving either or both of the plant and a source of the artificial light, wherein the intensity of lighting provided to the plant is increased by at least 3% each day for at least a portion of the life cycle of the plant.

### SUMMARY OF THE INVENTION

Plants use the process of photosynthesis to convert light, CO₂ and H₂O into carbohydrates (sugars). These sugars are used to fuel metabolic processes. The excess of sugars is used for biomass formation. This biomass formation includes stem elongation, increase of leaf area, flowering, fruit formation, etc. The photoreceptor responsible for photosynthesis is chlorophyll. Apart from photosynthesis, also photoperiodism, phototropism and photomorphogenesis are representative processes related to interaction between radiation and plants:
photoperiodism refers to the ability that plants have to sense and measure the periodicity of radiation (e.g. to induce flowering),
phototropism refers to the growth movement of the plant towards and away from the radiation, and
photomorphogenesis refers to the change in form in response to the quality and quantity of radiation.

Two important absorption peaks of chlorophyll a and b are located in the red and blue regions, especially from 625-675 nm and from 425-475 nm, respectively. Additionally, there are also other localized peaks at near-UV (300-400 nm) and in the far-red region (700-800 nm). The main photosynthetic activity seems to take place within the wavelength range 400-700 nm. Radiation within this range is called photosynthetically active radiation (PAR).

In the context of horticulture lighting, near-UV is defined as one or more wavelengths selected from the spectral range of 300-400 nm, blue is defined as one or more wavelengths selected from the spectral range of 400-500 nm, white is defined is defined as wavelengths selected from the spectral range of 400-700 nm (which selected wavelengths together may constitute white light, such as a combination of wavelengths in the blue and green and red), green is defined as one or more wavelengths selected from the spectral range of 500-600 nm, red is defined as one or more wavelengths selected from the spectral range of 600-700 nm, deep-red is defined as one or more wavelengths selected from the spectral range of 640-700 nm, and far-red is defined as one or more wavelengths selected from the spectral range of 700-800 nm. Deep-red is thus a sub selection of red.

Other photo sensitive processes in plants include phytochromes. Phytochrome activity steers different responses such as leaf expansion, neighbor perception, shade avoidance, stem elongation, seed germination and flowering induction. The phytochrome photo system includes two forms of phytochromes, Pr and Pfr, which have their sensitivity peaks in the red at 660 nm and in the far-red at 730 nm, respectively.

In horticulture, the photosynthetic photon flux density (PPFD) or “fluence” is measured in number of photons per second per unit of area (in μmol/sec/m²; a mol corresponding to 6·10²³ photons). In practice, when applying e.g. inter-lighting, especially for tomatoes, the red PPFD used may be typically 200 μmol/sec/m² and the ratio blue:red may be typically 1:7 (with red and blue especially selected from 625-675 nm and especially selected from 400-475 nm, respectively). Especially, the photosynthetic photon flux density may comprise about 10% blue and about 90% red. The PPFD can be determined from a photodiode or measured directly with a photomultiplier. The area in the PPFD refers to the local light receiving (plant) area of the space wherein the light source(s) are arranged. In case of a multi-layer system, it may be defined as the area of a relevant layer comprised in the multi-layer configuration; the PPFD may then be estimated in relation to each layer individually (see further also below). The area may be a value in an embodiment fed to the control unit manually, or may in an embodiment be evaluated (with e.g. sensors) by the control unit.

Plant growth depends not only on the amount of light but also on spectral composition, duration, and timing of the light on the plant. A combination of parameter values in terms of these aspects is called “light recipe” for growing the plant (herein, the words plant and crop can be interchanged).

LEDs can play a variety of roles in horticultural lighting such as:
1. Supplemental lighting: lighting that supplements the natural daylight is used in order to increase production (of tomatoes for example) or extend crop production during e.g. the autumn, winter, and spring period when crop prices may be higher.
2. Photoperiodic lighting: The daily duration of light is important for many plants. The ratio of the light and dark period in a 24-hour cycle in_{f} luences the blossoming response of many plants. Manipulating this ratio by means of supplemental lighting enables regulating the time of blossoming.
3. Cultivation without daylight in plant factories.
4. Tissue culture.

For providing supplemental lighting during autumn, winter and spring in green-houses (or all-year round in multi-layer growth), in general high-power gas-discharge lamps are used that have to be mounted at a relative high location above the plants to ensure sufficiently uniform light distribution across the plants. At present, in green houses different types of high-power lamps ranging from 600 up to 1000 W (e.g. high power HID) are used to provide plants with supplemental light. One drawback is that from the location above the plants the amount of light reaching the lower parts of the plant may be rather limited, dependent upon the type of crop. At the same time, the lower parts of the plant are often most in need of supplemental light. The same dilemma persists when using solid state lighting that is mounted above the plants. Nevertheless, LED lighting, especially solid-state lighting, has some advantages over discharge-based lighting.

In circumstances that plants get insufficient light from natural sunlight, e.g. in northern regions or in so-called “plant farming” or “vertical farming” that fully rely on artificial and well controlled conditions, there appears to be a need to provide light to the plant for growing (leaf and fruit), ripening and pre-harvest conditioning.

Light is not the only enabler for growth; also atmosphere (humidity level, CO₂/O₂ levels, etc.), water, nutrients and spore elements are of main importance. Temperature (and temperature profile/cycles over day/night) is also a key contributor to the success of growing plants. In the field of open-air horticulture, it seems that there is a need for soilless or hydroponic horticulture, typically used for now in high profit/high value cultivation. Such methods are also based on non-natural growing of plants and could require or profit from artificial optimizations.

The space available for food or other useful plant production is becoming scarcer. Innovation in production methods is needed to deliver higher yields from smaller footprints, while becoming more sustainable (minimum use of energy and water). Producing food in closed environments such as plant farms is a method to meet these demands. In plant farms (also known as plant factories, vertical farms or city farms), food is grown in multiple layers, making much better use of the available space as compared to outdoor growth or growth in greenhouses. This implies that daylight will not be able to reach all plants and nearly all the light has to come from artificial lighting. In plant farms, there is a need for providing to the plants a light treatment that is optimal at all times. At the same time, it is imperative that the light that is generated by the LED modules is used as efficiently as possible in order to reduce energy consumption and result in a profitable business. In plant farms, the production per unit of area is much higher than the production in the open field. The use of water is minimized. Plant diseases and pests can be prevented more easily.

In horticulture, relatively much light, and thus energy, is used. Producing more yield while using less photons is the key for the future of horticulture.

The term “horticulture” relates to (intensive) plant cultivation for human use and is very diverse in its activities, incorporating plants for food (fruits, vegetables, mushrooms, culinary herbs) and non-food crops (flowers, trees and shrubs, turf-grass, hops, grapes, medicinal herbs). Horticulture is the branch of agriculture that deals with the art, science, technology, and business of growing plants.

Herein, the term “plant” is used for essentially all stages. The term “plant part” may refer to root, stem, leaf, fruit (if any), etc. . . . The term “horticulture” relates to (intensive) plant cultivation for human use and is very diverse in its activities, incorporating plants for food (fruits, vegetables, mushrooms, culinary herbs) and non-food crops (flowers, trees and shrubs, turf-grass, hops, grapes, medicinal herbs). Horticulture is the branch of agriculture that deals with the art, science, technology, and business of growing plants.

The term “crop” is used herein to indicate the horticulture plant that is grown or was grown. Plants of the same kind grown on a large scale for food, clothing, etc., may be called crops. A crop is a non-animal species or variety that is grown to be harvested as e.g. food, livestock fodder, fuel, or for any other economic purpose. The term “crop” may also relate to a plurality of crops.

The term “horticulture light” especially refers to light having one more wavelengths in on or more of a first wavelength region of 400-475 nm and a second wavelength region of 625-675 nm. The relative energies (watt) that are provided in these regions may depend upon the type of plant and/or the growth phase. Hence, a recipe may define the ratio, optionally as function of time, for one or more types of plants. Especially, the term “horticulture light may refer to the PAR region (the photosynthetically active region from 400-700 nm). The term “horticulture light” may also be used for light that is applied to plants in hydroponic applications. As known in the art, in the PAR region (the photo-synthetically active region from 400-700 nm) the reflection coefficient of leaves is very low (5-10%). Towards the near in_{f} rared, beyond 700 nm, the reflection coefficient increases. In specific embodiments, the horticulture light, may in addition to PAR light also include (a small fraction (<20% of the power, especially about at maximum 10% of the power)) far red, i.e. 700-800 nm. Light recipes of horticulture light are also provided below.

The term “plant” herein may especially refer to a plant of the family Cannabaceae. According to US2016/0184237 plants of the family Cannabaceae possess commercial value and have many uses and applications which arise from the natural products that are extracted from their flowers. For instance, hops are extracted from the flowers of humulus plants in this family. Hemp has multiple uses, including food and as a fiber for making clothing, rope, etc. Cannabis plants have long been considered to have medicinal properties. Cannabinoids, which are compounds derived from cannabis, are a group of chemicals from Cannabis sativa or Cannabis indica plants that may especially activate cannabinoid receptors (i.e., CB1 and CB2) in cells. There may be at least 85 different cannabinoids that can be isolated from cannabis. These chemicals are also produced endogenously in humans and other animals and are termed endocannabinoids. Synthetic cannabinoids are man-made chemicals with the same structure as plant cannabinoids or endocannabinoids. Cannabinoids are cyclic molecules exhibiting particular properties such as the ability to easily cross the blood-brain barrier, weak toxicity, and few side-effects. The most notable cannabinoids are Δ9-Tetrahydrocannabinol (i.e., THC) and cannabidiol (i.e., CBD). Medical benefits attributable to one or more of the cannabinoids isolated from cannabis are also described in US2016/0184237.

Plant growth may especially be strongly in_{f} luenced by light. Among lighting characteristics, the main in_{f} luencers are the intensity, photoperiod and spectrum of the light. Hence, it appears desirable to optimize lighting conditions. It has been experienced that some lighting conditions may also have a detrimental impact on the growth of plants or their fruits. Hence, it is an aspect of the invention to provide an alternative lighting method, which preferably further at least partly obviates one or more of above-described drawbacks. The present invention may have as object to overcome or ameliorate at least one of the disadvantages of the prior art, or to provide a useful alternative.

In relation to cannabinoid plants, it was surprisingly found that when including one or more perturbations (herein also indicated as deviations) on the desirable on-off 24 hours lighting scheme during the flowering stage (and/or vegetative stage) this may substantially increase the dry matter weight. It surprisingly appeared that without substantially affecting or disturbing the flowering stage, only one or a few pulses may already have this effect.

Hence, in an aspect the invention provides a lighting method for providing light to a Cannabis plant during at least a flowering stage of the Cannabis plant, the method comprising: providing the horticulture light to the Cannabis plant during the flowering stage according to a flowering stage time scheme, wherein the flowering stage time scheme lasts n_{f} weeks and includes a flowering stage on-off schedule of the horticulture light wherein during each 24 hours the on-time is at least 10 hours and the off-time is at least 10 hours, except for k_{f} deviations from the flowering stage on-off schedule of the flowering stage time scheme, wherein each deviation includes an on-time selected in embodiments from the range of 24-72 hours , wherein in embodiments n_{f} is at least 4, such as especially at least 6, and wherein k_{f} is selected from the range of 1≤k_{f}≤n_{f}.

As indicated above, it appears that such plants, especially at least the flowers of such plants, may have an increased dry matter weight. In non-fully optimized lighting schemes, already a 5 wt % increase of the dry matter weight can be measured (from the flowers). Hence, the invention also provides (in an aspect) the use of k_{f} horticulture light pulses selected from the range of about 24-72 hours during the flowering stage of a Cannabis plant, wherein the flowering stage lasts n_{f} weeks, wherein n_{f} is at least 6, and wherein k_{f} is selected from the range of 1≤k_{f}≤n_{f}.

The invention provides in a further aspect a method for growing a Cannabis plant, especially for medicinal purposes, wherein the method comprises lighting the Cannabis plant according to the lighting method as described herein. Such method may further include controlling one or more of (i) supply of water to the plant, (ii) supply of nutrient to the plant, (iii) temperature of one or more of the leaves, stem, and roots, (iv) air flow, (v) humidity, (vi) gas composition, etc. etc. Such method may also include propagation of the plant. Further, such method may also include pruning the plant. Such method may also include harvesting plant parts, such as Cannabis flowers. Other control aspects in relation to horticulture may also be included.

Hence, the invention provides a lighting method for providing light to a Cannabis plant during at least a flowering stage of the Cannabis plant.

Herein, instead of the term “Cannabis plant” also the term “plant of the genus cannabis of the family of Cannabaceae may be used”. Cannabaceae is a small family of flowering plants. As now circumscribed, the family may include about 170 species grouped in about 11 genera, including Cannabis (hemp, marijuana), Humulus (hops) and Celtis (hackberries). The invention is especially directed to Cannabis. Cannabis is a genus of flowering plants in the family Cannabaceae. Three species may be recognized: Cannabis sativa, Cannabis indica, and Cannabis ruderalis. However, C. ruderalis, and even Cannabis indica, may be included within C. sativa. All three may be treated as subspecies of the single species C. sativa. Hence, the term “Cannabis” may herein refer to e.g. Cannabis sativa Cannabis indica, or Cannabis ruderalis.

The herein described method(s) especially include providing the horticulture light during at least a flowering stage of the Cannabis plant. Hence, the method is especially related to a horticulture application wherein essentially all light that the Cannabis plant receives during a major port of the flower stage is artificial light. Hence, the method(s) described herein are especially related to indoor horticulture application with the exclusion of essentially all daylight. For instance, less than 5% of the light the Cannabis plant receives during the flowering stage is daylight, such as equal to or less than 1%.

In general, a Cannabis plant has a vegetative stage and a flower stage. The latter may be initiated by substantially increasing the time the Cannabis plant essentially does not receive light (dark period). Here below, some in_{f} ormation is provided in relation to Cannabis cultivation.

In_{f} ormation on Cannabis growth can be found on the internet, e.g. https://www.growweedeasy.com/cannabis-flowering-stage. This web page and other pages indicate amongst others that during the phase of life known as the vegetative stage (the first stage of life for marijuana), a cannabis plant grows like a weed. In the vegetative stage a cannabis plant essentially only grows new stems and leaves, and can grow several inches a day. When growing Cannabis indoors, the flowering stage begins when the lighting schedule is reduced to a 12/12 light cycle (12 hours light, 12 hours darkness each day). During the vegetative stage, the Cannabis plant should get horticulture light during at least about 16 hours a day. Getting those 12 hours of uninterrupted darkness each day may give the plant the signal that it is time to start flowering. The plant may receive a kind of winter trigger, because the days are getting short. On the internet, it is amongst others found that “if the plant gets any light during the dark period, even for just a minute, it will not make buds! A flowering plant may even revert back or express hermaphroditism if it gets any light at night”. During the first few weeks after being switched to a 12/12 schedule, the Cannabis plant will be growing relatively fast and may rapidly gain height. In fact, a Cannabis plant can almost double in height after the switch to 12/12. This period of super-fast and often stretchy growth is sometimes referred to as the “flowering stretch”. The female plants will start sprouting lots of white pistils, though they usually will not start growing “real” buds with substance quite yet. Only female cannabis plants make buds. When the Cannabis plant is male, it will start growing distinct pollen sacs. Male plants may be removed from the horticulture stage of the Cannabis plants. During the first few weeks of the flowering stage, one may see bunches of single leaves forming at the tops of the main colas (the flowering site of a female cannabis plant. Note that the cola actually consists of the entire flower, as well as its connection to the larger plant). Soon, white pistils may start coming out of the middle of the bunches, and they may become the main buds. During week 1-3 of the flowering stage, the Cannabis plant will mostly be producing new stems and leaves as it grows taller. Now, the Cannabis plant is still very resilient and can handle problems just like in the vegetative stage. As part of the stretch, the Cannabis plant will be growing out its bud sites. Stunting growth at this point could cause the plant to make smaller and fewer bud sites than it would if it were healthy and growing fast. In this stage, the new stems may easily be bend; in this way the Cannabis plant (stems) can be guided to a desired shape and e.g. optimal light receipt. In this way, bud yield may be increased. In about week 3-4 (hairy) budlets are formed. The relatively large stretching of the first few weeks will start to slow down in week 3-4. The cannabis plant will still be growing upward. At this point real buds are formed instead of just hairs and pistils will be white and sticking almost straight out. As the Cannabis plant continues through the flowering stage, it is normal to see a few yellow or discolored leaves near the bottom of the plant, especially in the places where the leaves are no longer getting light. The Cannabis plant may also start smelling. In week 4-6 the buds start gaining volume. The buds may still have nearly all white pistils sticking straight up in every direction, but the buds themselves will be getting fatter every day. By weeks 4-6, the stretch is almost over. In about week 6-8 the buds may (further) ripen and pistils may darken. In this period, the Cannabis plant will essentially not be making any new leaves or stems. It has essentially switched gears away from vegetative growth and all its energy will be focused on growing buds from now until harvest. It is not unusual that some of the bottom leaves begin to turn yellow as the plant continues to put its energy in the leaves and buds getting the most direct light, though the plant should still be mostly green from top to bottom even in week 6-8. At about week 7 of the flowering stage, the Cannabis plant should still be mostly green and healthy, though it is normal to start losing a few leaves here and there, especially towards the bottom of the plant. In about week 8 and further flowering may terminate and the flowers may be harvested. Once the Cannabis plant has reached about week 8, buds are fattening quickly. Trichomes and pistils are maturing, though new pistils may continue to develop on the buds as they grow. Different strains may be ready at different times. In the period of about 8-10 weeks after the light scheme change to more dark hours , the buds may have completely mature; the smell may also be relatively strong. After about week 8 it may be normal to see leaves turning yellow.

Hence, the light recipe change from about 18 (or more) hours a day light to about 12 hours a day triggers the start of the flowering stage. The change from vegetation state to flowering stage (where the first flower buds appear) may take approximately about a week to three weeks, depending on the cultivar. Therefore, the Cannabis plant begins flowering when the plant receives less light per day. Usually this is after about 1-4 weeks of vegetative growth (see further also below).

Therefore, the method may comprise providing the horticulture light to the Cannabis plant during the flowering stage according to a flowering stage time scheme, wherein the flowering stage time scheme lasts o_{f} weeks and includes a flowering stage on-off schedule of the horticulture light wherein during each 24 hours the on-time is at least 10 hours and the off-time is at least 10 hours.

Therefore, during the flowering stage according to the flowering stage time scheme horticulture light is (not) provided to the Cannabis plant. The flowering stage time scheme defines the on-time and off-time, i.e. a (first) period during each 24-hours period the horticulture light is provided and (second) period during each 24-hours period the horticulture light is not provided. As indicated above, the Cannabis plant may essentially only receive horticulture light and no other light, especially essentially no daylight.

The phrase “providing the horticulture light to the Cannabis plant during the flowering stage according to a flowering stage time scheme” may also refer to providing the horticulture light to the Cannabis plant during a part of the total time (such as a few weeks) of the flowering stage according to a flowering stage time scheme.

As indicated above, the flowering stage may be triggered and commenced by having 24 hours periods with at least 10 hours essentially darkness. Would there be light during the off-time, the time averaged fluence may be less than 50 μmol/m²/s, such as less than about 25 μmol/m²/s, such as less than about 10 μmol/m²/s, or even less than about 5 μmol/m²/s, yet even more especially less than about 1 μmol/m²/s. In other embodiments, the fluence during the off-time is at least 10 times smaller than during the on-time (see further also below).

The off-time (during the flowering stage) is at least 10 hours, such as in the range of 10-14 hours; the on-time is also at least 10 hours, such as in the range of 10-14 hours (both counting up to 24 hours). Especially, in embodiments during each 24 hours of the flowering stage on-off schedule of the flowering stage time scheme the on-time is at least 11 hours , such as 12 hours, and the off-time is at least 11 hours, such as 12 hours, except for the k_{f} deviations from the flowering stage on-off schedule of the flowering stage time scheme. The total on-time and off-time during 24 hours is of course 24 hours.

The flowering stage may differ from type to type, but may in general be in the order of 6-12 weeks, such as about 7-10 weeks or some strains may even flower as long as 16 weeks. Hence, n_{f} is at least 6, in general at least 7, such as in the range of 6-12. Note that there is no necessity to have the flowering stage counted in terms of multiple weeks. In principle, n_{f} is not necessarily a natural number.

In the present invention, however, contrary to light recipes given in the prior art, the light recipe during the flowering stage is interrupted with one or more pulses of light substantially lasting longer than the regular on-time during the flowering stage. Hence, herein the flowering stage time scheme lasts n_{f} weeks and includes a flowering stage on-off schedule of the horticulture light wherein during each 24 hours the on-time (“regular on-time”) is at least 10 hours and the off-time is at least 10 hours, except for k_{f} deviations from the flowering stage on-off schedule of the flowering stage time scheme. Each deviation may include an on-time (“deviation on-time”) selected from the range of 24-72 hours. For instance, instead of 12 hours on-time, the on-time may (temporarily) be 24 hours or longer. A (deviation) pulse smaller than 12 additional hours may not have enough effect on the Cannabis plant. Hence, especially the minimum additional time is 12 hours, i.e. an incidental on-time of at least 24 hours. An advantage of using on-times of 36 h or 60 h is that the off-time is again in-sync with the normal on-off schedule. On-times of longer than 72 hours may disturb the flowering stage too much and may have undesired effects on the Cannabis plant (such as decay of the plant, necroses development on the leaves, etc.). The deviating pulse may be executed one or more times, separated by at least a single regular off-time of at least 10 hours, such as about 12 hours. The number of deviations, however, may be limited, such as in average not more than the number of weeks. This does not necessarily mean that each week a pulse of 24 or more hours is provided. For instance, there may be one or two of such pulses only in week 8.

Hence, k_{f} is selected from the range of 1≤k_{f} ≤n_{f}. The number k_{f} is especially a natural number. The number n_{f} in this equation is the number of weeks. Would this number n_{f} not be a natural number, then the number n_{f} for the interpretation of this specific equation (1≤k_{f}≤n_{f}) is rounded down (to a natural number). Hence, 1≤k_{f}≤n_{f} may also be interpreted as 1≤k_{f}≤n_{f}*, wherein n_{f}* is down rounded n_{f}. Hence, when e.g. n_{f} is 6, k_{f} may be 1, 2, 3, 4, 5 or 6. Would n_{f} be 7.5, k_{f} might be 1, 2, 3, 4, 5, 6, or 7. Likewise, this applies to similar equations. In specific embodiments, 1≤k_{f}≤6. In more specific embodiments, 1≤k_{f}≤4. This may be a good balance between increase of solid matter weight percentage and disturbance of the flowering stage.

The invention is especially related to the flowering stage. However, some of the embodiments are also directed to the preceding vegetative stage. As the flower stage succeeds the vegetative stage, the flowering stage may also be indicated as the second stage and the vegetative stage may also be indicated as first stage. Likewise, the flowering stage on-off schedule may also be indicated as second on-off schedule, and the vegetative stage on-off schedule (see below) may also be indicated as first stage on-off schedule. Similarly, the flowering stage time scheme may also be indicated as second time scheme, and the vegetative stage time scheme (see below) may also be indicated as first time scheme.

As is clear from the above, the deviation from the flowering stage on-off schedule of the flowering stage time scheme may especially not be executed in the first weeks after the change in light recipe to the flowering stage on-off schedule to avoid the risk of jeopardizing the flower development and reverting the plant back to vegetative growth. Whatever goes wrong during the first weeks of flower development cannot be corrected in the remaining weeks of the flowering stage.Therefore, in embodiments (of the method) the flowering stage time scheme lasts at least two (unperturbed) weeks before a first of the k_{f} deviations from the flowering stage on-off schedule of the flowering stage time scheme takes place. In this way, the Cannabis plant can get and stay in the flowering stage and the start of the flowering stage is not frustrated. Especially, the deviation(s) may be executed in the second half of the flowering stage, or especially at the end of the flowering stage. Therefore, in embodiments n_{f} is at least 6 and the flowering stage time scheme lasts at least four weeks before a first of the k_{f} deviations from the flowering stage on-off schedule of the flowering stage time scheme takes place. Even more especially, in embodiments n_{f} is at least 8, and the flowering stage time scheme lasts at least six weeks before a first of the k_{f} deviations from the flowering stage on-off schedule of the flowering stage time scheme takes place. Note that the phrase “first of the k_{f} deviations” may also refer to a single deviation (i.e. k_{f}=1).

Especially, in embodiments the horticulture light during the on-time during the flowering stage time scheme has a flowering stage light spectral power composition as defined in table 1. In the table below, the composition of the horticulture light during the on-time during the flowering stage time scheme is further elucidated:

Tables 1a-1b: the composition of the horticulture light during the on-time during the flowering stage time scheme in terms of deep-red (DR), far-red (FR), blue (B), and green (G) (see also FIGS. 3a-3d for the spectral power distributions) (table 1a) or in terms of intensities in the spectral ranges/spectral power distributions) (table 1b)

| Horticulture | % (of the total power of the horticulture light |
|---|---|
| light type | during the on-time during the flowering stage) |
| DR | 50-90, especially 70-90 |
| FR | 0-50, especially 0-15 |
| B | 0-30, especially 5-30 |
| G | 0-25, especially 0-20 |

| | Spectral power distribution % (of the total |
|---|---|
| Spectral | power of the horticulture light during |
| range (nm) | the on-time during the flowering stage) |
| 300-400 | <5, especially less than 1 |
| 400-500 | 0-30, especially 5-30 |
| 500-600 | 0-25, especially 0-20 |
| 600-700 | 50-90, especially 70-90 |
| 700-800 | 0-50, especially 0-15 |

Hence, in embodiments the horticulture light during the flowering stage, during the regular on-times (and also during the deviation on-times) may comprise less than 5%, such as less than 1%, of the spectral power distribution in the range of 300-800 nm in the range of 300-400 nm.

In embodiments, the horticulture light during the flowering stage, during the regular on-times (and also during the deviation on-times) may comprise in the range of 0-30%, such as especially in the range of 5-30%, of the spectral power distribution in the range of 300-800 nm in the range of 400-500 nm.

In embodiments, the horticulture light during the flowering stage, during the regular on-times (and also during the deviation on-times) may comprise in the range of 0-25%, such as especially in the range of 0-20%, of the spectral power distribution in the range of 300-800 nm in the range of 500-600 nm.

In embodiments, the horticulture light during the flowering stage, during the regular on-times (and also during the deviation on-times) may comprise in the range of 50-90%, such as especially in the range of 70-90%, of the spectral power distribution in the range of 300-800 nm in the range of 600-700 nm.

In embodiments, the horticulture light during the flowering stage, during the regular on-times (and also during the deviation on-times) may comprise in the range of 0-50%, such as especially in the range of 0-15%, of the spectral power distribution in the range of 300-800 nm in the range of 700-800 nm.

In specific embodiments, the method may comprise: providing the horticulture light during the on-time during the flowering stage time scheme with a flowering stage photosynthetic photon flux density selected from the range of 400-1200 μmol/m²/sec, especially 500-1000 μmol/m²/sec. This range of photosynthetic photon flux densities suggested during the flowering stage is well below sunlight photosynthetic photon flux densities which go beyond 2000 μmol/m2/sec.

The photosynthetic photon flux density of the horticulture light during the on-time during the flowering stage is especially higher than during the on-time during the vegetative stage (see also below).

The photosynthetic photon flux density during a deviating on-time pulse and/or the duration of a deviating on-time pulse are especially be selected to stress the plant without however damaging the plant. It is known that Cannabis is a very tough plant which ‘always grows no matter what’, like weed, and can handle a lot of stress situations. Cannabis performs best at a daily light integral (DLI), defined as photosynthetic photon flux density×duration over a 24 hour period, and intensities, referred herein as photosynthetic photon flux densities, where most other plants would struggle.

Stressing the plant is common practice in cannabis. Cannabis plants are pruned, they are cut all the time, starved (by providing less nutrient) and drought stressed, all for creating the urge for the female plant to feel her time is near and that it should produce flowers to make the species survive and attract pollinators. Illumination is another means for inducing stress to plants. Of course, when stressing the plant using light, the skilled person will know that the irrigation should be adapted to ensure the plant does not de-hydrate. It is further noted that the plant is not continuously stressed during the flowering stage but only for k_{f} deviations in n_{f} weeks of flowering. Stress conditions in the flowering stage are intended to incentive the cannabis plants to focus on protecting flowers and build a higher cannabinoid profile. When such stress conditions are further accompanied with additional light energy, the additional energy is used to create bigger flowers. After all, the purposed of growing cannabis plants is not to have a beautiful plant at the end of the day but to have high qaulity and high quantity of cannabinoids.

The photosynthetic photon flux density of the horticulture light during the deviation on-time(s) may be the same as during regular on-times during the flowering stage. However, they may also differ; for instance, during the deviation on-time(s) the photosynthetic photon flux density of the horticulture light may be smaller than during the regular on-times. Especially, however, whether the same or different, the photosynthetic photon flux density is selected from above-indicated range (for the flowering stage photosynthetic photon flux density).

Hence, in specific embodiments the far-red content during the deviation on time (in the flowering stage) may be larger, or during at least part of the deviation on-time, may be larger than during the regular on-time in the flowering stage. Alternatively or additionally, in embodiments the blue content during the deviation on time (in the flowering stage) may be larger, or during at least part of the deviation on-time, may be larger than during the regular on-time in the flowering stage. For instance, the blue content may e.g. be at least 50% (during (at least part of) the deviation on-time in the flowering stage, whereas during the regular on-time the blue content may be up to 30%, relative to the total spectral power in the range of 300-800 nm).

As indicated above, the lighting method may further comprise providing light to the Cannabis plant during the vegetative stage (which precedes the flowering stage). Hence, in embodiments the lighting method may further comprise providing horticulture light to the Cannabis plant during the vegetative stage according to a vegetative stage time scheme, wherein the vegetative stage time scheme lasts nᵥ weeks and comprises a vegetative stage on-off schedule of the horticulture light wherein during each 24 hours the on-time (“regular on-time” during the vegetative stage) is especially at least 16 hours and the off-time is especially at least 4 hours, except for kᵥ deviations from the vegetative stage on-off schedule of the vegetative stage time scheme, wherein in specific embodiments each deviation includes an on-time selected from the range of 24-72 hours, wherein nᵥ is at least 1, and wherein in specific embodiments kᵥ is selected from the range of 0≤kᵥ≤nᵥ, especially 0≤kᵥ<nᵥ, even more especially 1≤kᵥ<nᵥ.

Therefore, the method may comprise providing the horticulture light to the Cannabis plant during the vegetative stage according to a vegetative stage time scheme, wherein the vegetative stage time scheme lasts nᵥ weeks and includes a vegetative stage on-off schedule of the horticulture light wherein during each 24 hours the on-time is at least 16 hours and the off-time is at least 4 hours.

Therefore, during the vegetative stage according to the vegetative stage time scheme horticulture light is (not) provided to the Cannabis plant. The vegetative stage time scheme defines the on-time and off-time, i.e. a (first) period during each 24-hours period the horticulture light is provided and (second) period during each 24-hours period the horticulture light is not provided. As indicated above, the Cannabis plant may essentially only receive horticulture light and no other light, especially essentially no daylight.

Would there be light during the off-time during the vegetative stage, the time averaged fluence may be less than 25 μmol/m²/s, such as less than about 15 μmol/m²/s, such as less than about 10 μmol/m²/s. In other embodiments, the fluence during the off-time is at least 10 times smaller than during the on-time (see further also below).

The off-time (during the vegetative stage) is at least 4 hours, such as in the range of 4-8 hours; the on-time is at least 16 hours, such as in the range of 16-20 hours (both counting up to 24 hours). Especially, in embodiments during each 24 hours of the vegetative stage on-off schedule of the vegetative stage time scheme the on-time is at least 16 hours and the off-time is at least 4 hours, except for the k_{f} deviations from the vegetative stage on-off schedule of the vegetative stage time scheme. The total on-time and off-time during 24 hours is of course 24 hours.

In specific embodiments, during each 24 hours of the vegetative stage on-off schedule of the vegetative stage time scheme the on-time is at least 17 hours and the off-time is at least 5 hours, except for the k_{f} deviations from the vegetative stage on-off schedule of the vegetative stage time scheme. Hence, in embodiments (each day) the on-time may be about 18 hours and the off-time may be about 6 hours. Most efficient growth may be achieved with such schedule during the vegetative stage.

The vegetative stage may differ from type to type, but may in general be in the order of 1-4 weeks, such as about 2-4 weeks. Hence, wherein is at least 1, in general at least 2, such as in the range of 2-4. Note that there is no necessity to have the vegetative stage counted in terms of multiple weeks. In principle, is not necessarily a natural number.

A pulse of horticulture light deviation from the on-off schedule appears also to be useful during the vegetative stage, especially at the end thereof. The pulse could be used at about the end of the vegetative stage to enhance the flower induction.

In the present invention, however, contrary to light recipes given in the prior art, the light recipe during the vegetative stage may in embodiments also interrupted with one or more pulses of light substantially lasting longer than the regular on-time during the vegetative stage. Hence, herein the vegetative stage time scheme lasts nᵥ weeks and includes a vegetative stage on-off schedule of the horticulture light wherein during each 24 hours the on-time is at least 16 hours and the off-time is at least 4 hours, except for kᵥ deviations from the vegetative stage on-off schedule of the vegetative stage time scheme. Each deviation may include an on-time selected from the range of 24-72 hours. For instance, instead of 18 hours on-time, the on-time may be 30 hours or longer. A pulse smaller than 12 additional hours may not have enough effect on the Cannabis plant. Hence, especially the minimum additional time is 12 hours, i.e. an incidental on-time of at least 24 hours. An advantage of using on-times of 36 h or 60 h is that the off-time is again in-sync with the normal on-off schedule. On-times of longer than 72 hours may disturb the vegetative stage too much and may have undesired effects on the Cannabis plant (such as decay of the plant, necroses development on the leaves, etc.). The deviating pulse may be executed one or more times, separated by at least a single regular off-time of at least 4 hours, such as about 6 hours. The number of deviations, however, may be limited, such as in average not more than the number of weeks. This does not necessarily mean that each week a pulse of 24 or more hours is provided. For instance, there may be two of such pulses only in week 2.

Hence, kᵥ may be selected from the range of 1≤kᵥ≤nᵥ, especially 1≤kᵥ<nᵥ. The number kᵥ is especially a natural number. The number nᵥ in this equation is the number of weeks. Would this number nᵥ not be a natural number, then the number nᵥ for the interpretation of this specific equation (1≤kᵥ≤nᵥ) is rounded down (to a natural number). Hence, 1≤kᵥ≤nᵥ may also be interpreted as 1≤kᵥ≤nᵥ*, wherein nᵥ* is down rounded nᵥ. Hence, when e.g. nᵥ is 2, kᵥ may be 1 or 2 (or zero, see also above). Would nᵥ be 3.5, kᵥ might be 1, 2, or 3 (or zero, see also above). Likewise, this applies to similar equations. In specific embodiments, subject to the condition of kᵥ≤nᵥ (or kᵥ<nᵥ) nᵥ will in general not be larger three, such as at maximum 2. This may be a good balance between triggering the change from the vegetative stage to the flowering stage.

As indicated above, the vegetative stage may also be indicated as first stage. Likewise, the vegetative stage on-off schedule may also be indicated as first stage on-off schedule. Similarly, the vegetative stage time scheme may also be indicated as first time scheme.

As indicated above, the horticulture light pulse deviation from the on-off schedule during the vegetative stage is especially proved at the end of the vegetative stage. Hence, in embodiments wherein kᵥ≥1, the lighting method may comprise: providing the kᵥ deviations from the vegetative stage on-off schedule of the vegetative stage time scheme during the last five days, especially during a time period of the last three days of the vegetative stage time scheme preceding the flowering stage time scheme. More especially, after such deviation pulse from the vegetative stage on-off schedule, the flowering stage may be commenced by changing to the flowering stage on-off schedule. Therefore, in embodiments the lighting method may comprise: commencing the flowering stage time scheme subsequent to a (final) deviation from the vegetative stage on-off schedule of the vegetative stage time scheme.

Especially, in embodiments the horticulture light during the on-time during the vegetative stage time scheme has a vegetative stage light spectral power composition as defined in table 1.

Therefore, in embodiments the horticulture light during the vegetative stage, during the regular on-times (and also during the deviation on-times) may comprise less than 5%, such as less than 1%, of the spectral power distribution in the range of 300-800 nm in the range of 300-400 nm.

In embodiments, the horticulture light during the vegetative stage, during the regular on-times (and also during the deviation on-times) may comprise in the range of 0-30%, such as especially in the range of 5-30%, of the spectral power distribution in the range of 300-800 nm in the range of 400-500 nm.

In embodiments, the horticulture light during the vegetative stage, during the regular on-times (and also during the deviation on-times) may comprise in the range of 0-25%, such as especially in the range of 0-20%, of the spectral power distribution in the range of 300-800 nm in the range of 500-600 nm.

In embodiments, the horticulture light during the vegetative stage, during the regular on-times (and also during the deviation on-times) may comprise in the range of 50-90%, such as especially in the range of 70-90%, of the spectral power distribution in the range of 300-800 nm in the range of 600-700 nm.

In embodiments, the horticulture light during the vegetative stage, during the regular on-times (and also during the deviation on-times) may comprise in the range of 0-50%, such as especially in the range of 0-15%, of the spectral power distribution in the range of 300-800 nm in the range of 700-800 nm. However, especially the far red content is low, such as less than 5%, such as less than 1%, during the vegetative stage.

In specific embodiments, the method may comprise: providing the horticulture light during the on-time during the vegetative stage time scheme with a vegetative stage photosynthetic photon flux density selected from the range of 100-500 μmol/m²/sec, especially 300-400 μmol/m²/sec.

The photosynthetic photon flux density of the horticulture light during the on-time during the vegetative stage is especially lower than during the on-time during the flowering stage (see also above).

The photosynthetic photon flux density of the horticulture light during the deviation on-time may be the same as during regular on-times during the vegetative stage. However, they may also differ; for instance, during the deviation on-time(s) the photosynthetic photon flux density of the horticulture light may be smaller than during the regular on-times. Especially, however, whether the same or different, the photosynthetic photon flux density is selected from above-indicated range (for the vegetative stage photosynthetic photon flux density).

Hence, in embodiments the horticulture light during the on-time during the vegetative stage time scheme has a vegetative stage light spectral power composition as defined above (in table 1), and the horticulture light during the on-time during the flowering stage time scheme has a flowering stage light spectral power composition as also defined above (in table 1).

In embodiments, the horticulture light during the on-time according to the vegetative stage on-off schedule of the vegetative stage time scheme has a first vegetative stage spectral power composition as indicated above in table 1, and the horticulture light during the on-time of the kᵥ deviations from the vegetative stage on-off schedule of the vegetative stage time scheme has a second vegetative stage spectral power composition also as defined in table 1. However, as indicated above, the far red content may be lower in the vegetative stage than in the flowering stage.

Hence, in embodiments (of the lighting method) the horticulture light during the on-time during the vegetative stage time scheme has a vegetative stage light spectral power composition; and the horticulture light during the on-time during the flowering stage time scheme (also) has a flowering stage light spectral power composition; especially a far red content in the vegetative stage light spectral power composition is lower than in the flowering stage light spectral power composition. For instance, the ratio of the far red content in the vegetative stage light spectral power composition to far red content in the in the flowering stage light spectral power composition may be <0.9, such as <0.8, like <0.7. Other values, however, may also be possible.

The spectral power composition of the horticulture light may thus be the same during the on-time of the regular on-off schedule and the on-time during a deviation pulse. However, it was also observed in an experiment that far-red may enhance this signaling when used at the end of the day when shifting from a situation of 24 h light (with e.g. no far red) to a 12 h horticulture light of the flowering stage with last one or two hours with a relatively high contribution of far-red. The plant may interpret this as “winter is coming” and start flowering. Far-red seems to have an interaction with photoperiod which is not yet elucidated in literature. Hence, in specific embodiments the horticulture light during a first part of a deviation on-time according to the vegetative stage on-off schedule of the vegetative stage time scheme has an initial vegetative stage deviation pulse spectral power composition, and wherein the horticulture light during a second part of the deviation on-time according to the vegetative stage on-off schedule of the vegetative stage time scheme has a final vegetative stage deviation pulse spectral power composition with an increased far red content relative to the first part, wherein the first part of each on-time is at least 8 hours, and wherein the second part of each on-time is at least 0.5 hours, such as at least 1 hour. The term “initial vegetative stage deviation pulse spectral power composition” and similar terms, refer to the spectral power composition of the horticulture light during a first part of a deviation on-time (“pulse”) during the vegetative stage. Likewise, term “final vegetative stage deviation pulse spectral power composition” and similar terms, refer to the spectral power composition of the horticulture light during a second part (later than the first part) of a deviation on-time (“pulse”) during the vegetative stage.

Hence, in specific embodiments the far-red content during the deviation on time (in the vegetative stage) may be larger, or during at least part of the deviation on-time, may be larger than during the regular on-time in the vegetative stage. Alternatively or additionally, in embodiments the blue content during the deviation on time (in the vegetative stage) may be larger, or during at least part of the deviation on-time, may be larger than during the regular on-time in the vegetative stage. For instance, the blue content may e.g. be at least 50% (during (at least part of) the deviation on-time in the vegetative stage, whereas during the regular on-time the blue content may be up to 30%, relative to the total spectral power in the range of 300-800 nm).

The lighting method may further comprise a lighting schedule for the propagation stage. This is a stage wherein the horticulture plants are bred but may also be multiplied by cutting and growing cuttings or tissue culture. Hence, in embodiments the lighting method may further comprise a propagation lighting stage preceding the vegetative stage time scheme, wherein the propagation lighting stage comprises: providing horticulture light to the Cannabis plant according to a propagation stage time scheme, wherein the propagation stage time scheme lasts n3 weeks and comprises a propagation stage schedule of the horticulture light wherein during each 24 hours the on-time is selected from the range of 22-24 hours, wherein n3 is at least 1. For instance, n3 may be selected from the range of 1-4 weeks, like 1-3 weeks.

Especially, in embodiments the horticulture light during the on-time during the propagation stage time scheme has a propagation stage light spectral power composition as defined in table 1.

Therefore, in embodiments the horticulture light during the propagation stage, during the regular on-times (and also during the deviation on-times) may comprise less than 5%, such as less than 1%, of the spectral power distribution in the range of 300-800 nm in the range of 300-400 nm.

In embodiments, the horticulture light during the propagation stage, during the regular on-times (and also during the deviation on-times) may comprise in the range of 0-30%, such as especially in the range of 5-30%, of the spectral power distribution in the range of 300-800 nm in the range of 400-500 nm.

In embodiments, the horticulture light during the propagation stage, during the regular on-times (and also during the deviation on-times) may comprise in the range of 0-25%, such as especially in the range of 0-20%, of the spectral power distribution in the range of 300-800 nm in the range of 500-600 nm.

In embodiments, the horticulture light during the propagation stage, during the regular on-times (and also during the deviation on-times) may comprise in the range of 50-90%, such as especially in the range of 70-90%, of the spectral power distribution in the range of 300-800 nm in the range of 600-700 nm.

In embodiments, the horticulture light during the propagation stage, during the regular on-times (and also during the deviation on-times) may comprise in the range of 0-50%, such as especially in the range of 0-15%, of the spectral power distribution in the range of 300-800 nm in the range of 700-800 nm. However, the far red content may be relatively high, such as at least 25%.

The photosynthetic photon flux density of the horticulture light during the on-time during the propagation stage is especially lower than during the on-time during the vegetative stage (see also above). In embodiments, the photosynthetic photon flux density is selected from the range of 70-150 μmol/m²/sec during the on-time during the propagation stage time scheme.

Therefore, in specific embodiments the method may comprise: providing the horticulture light during the on-time during the vegetative stage time scheme with a vegetative stage photosynthetic photon flux density selected from the range of 100-500 μmol/m²/sec; providing the horticulture light during the on-time during the flowering stage time scheme with a flowering stage photosynthetic photon flux density selected from the range of 400-1200 μmol/m²/sec, wherein the flowering stage photosynthetic photon flux density is larger than the vegetative stage photosynthetic photon flux density; and providing the horticulture light during the on-time during the propagation stage time scheme with a propagation stage photosynthetic photon flux density selected from the range of 70-150 μmol/m²/sec.

In yet a further aspect, the invention provides a computer program product, when running on a computer which is functionally coupled to or comprised by a horticulture lighting system (see also below) configured to generate in a controlling mode horticulture light (as defined herein), is capable of bringing about the method as defined herein. Therefore, the invention further provides a computer program product enabled to carry out the method as defined herein, for instance when loaded on a computer (that is functionally coupled to the horticulture lighting system or horticulture lighting apparatus). In yet a further aspect, the invention provides a record carrier (or data carrier, such as a USB stick, a CD, DVD, etc.) storing a computer program according to claim. Hence, the computer program product, when running on a computer or loaded into a computer, brings about, or is capable of bringing about, the method as described herein. Therefore, in a further aspect the invention provides a computer program product, when running on a computer which is functionally coupled to or comprised by a horticulture lighting system, especially as defined herein, or a horticulture arrangement, especially as defined herein, (and thus) comprising such horticulture lighting system, is capable of bringing about the method as described herein.

The record carrier or computer readable medium and/or memory may be any recordable medium (e.g., RAM, ROM, removable memory, CD-ROM, hard drives, DVD, floppy disks or memory cards) or may be a transmission medium (e.g., a network comprising fiber-optics, the world-wide web, cables, and/or a wireless channel using, for example, time-division multiple access, code-division multiple access, or other wireless communication systems). Any medium known or developed that can store information suitable for use with a computer system may be used as the computer-readable medium and/or memory. Additional memories may also be used. The memory may be a long-term, short-term, or a combination of long- and-short term memories. The term memory may also refer to memories. The memory may configure the processor/controller to implement the methods, operational acts, and functions disclosed herein. The memory may be distributed or local and the processor, where additional processors may be provided, may be distributed or singular. The memory may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network, such as the Internet, is still within memory, for instance, because the processor may retrieve the information from the network.

The controller/processor and the memory may be any type. The processor may be capable of performing the various described operations and executing instructions stored in the memory. The processor may be an application-specific or general-use integrated circuit(s). Further, the processor may be a dedicated processor for performing in accordance with the present system or may be a general-purpose processor wherein only one of many functions operates for performing in accordance with the present system. The processor may operate utilizing a program portion, multiple program segments, or may be a hardware device utilizing a dedicated or multi- purpose integrated circuit.

The invention also provides a computer program product, which, when running on a computer which is functionally coupled to or comprised by a horticulture lighting system (or horticulture lighting apparatus), is configured to generate in a controlling mode supplemental horticulture light (i.e. the supplemental controlling mode), wherein the horticulture light is provided such that the above-indicated fluence and above-indicated spectral power distribution of the horticulture light is obtained, based on the contribution of the supplemental horticulture light provided by the horticulture lighting system and optionally other light, such as daylight.

As indicated above, the invention also provides a method for growing a Cannabis plant, especially for medicinal purposes, wherein the method comprises lighting the Cannabis plant according to the lighting method as defined herein. To this end, a horticulture lighting system may be applied.

Hence, in yet a further aspect the invention provides a horticulture lighting system, comprising:
a lighting apparatus configured to provide horticulture light;
a control system configured to control the lighting apparatus to provide during a controlling mode horticulture light according to the method as defined herein.

Hence, the lighting apparatus may be configured to provide lighting apparatus light, such as horticulture light, with in specific embodiments a controllable spectral power distribution, wherein in a controlling mode (of the apparatus) the horticulture light is provided, as defined herein. Hence, in embodiments the lighting apparatus comprises a lighting control system or may be functionally coupled to a lighting control system that is configured to control the spectral properties of the lighting apparatus. In embodiments, this may be the control system as further defined in relation to the horticulture lighting system. In yet other embodiments, the lighting apparatus is configured to provide essentially a single spectral distribution, i.e. the spectral distribution of the first horticulture light.

The lighting apparatus comprises a light source for providing the horticulture light, such as at least the horticulture light. The lighting apparatus may comprise a device, with a device housing, wherein the device housing comprises the light source.

The term “light source” may refer to a semiconductor light-emitting device, such as a light emitting diode (LEDs), a resonant cavity light emitting diode (RCLED), a vertical cavity laser diode (VCSELs), an edge emitting laser, etc. . . . The term “light source” may also refer to an organic light-emitting diode, such as a passive-matrix (PMOLED) or an active-matrix (AMOLED). In a specific embodiment, the light source comprises a solid-state light source (such as a LED or laser diode). In an embodiment, the light source comprises a LED (light emitting diode). The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. In embodiments, a COB is a multi LED chip configured together as a single lighting module. The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as a LED, or downstream of a plurality of solid-state light sources (i.e. e.g. shared by multiple LEDs). In embodiments, the light source may comprise a LED with on-chip optics. In embodiments, the light source comprises a pixelated single LEDs (with or without optics) (offering in embodiments on-chip beam steering).

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

Especially, the lighting apparatus comprises a plurality of light sources for providing the horticulture light, such as at least the first horticulture light. Two or more light sources, or all light sources together, may be configured to provide in the controlling mode the first horticulture light. Hence, especially the lighting apparatus comprises a plurality of different light sources for providing the horticulture light.

In embodiments, the lighting apparatus may comprise a plurality of light sources, especially solid-state light sources. In further embodiments, two or more subsets of these light sources may independently controllable. Yet further, two or more of (such) subsets may provide light with different spectral distributions. In such embodiments, intensity and spectral distribution of the horticulture light may be controllable. Hence, the two or more subsets may in embodiments be configured to provide light with different spectral distributions.

Hence, in embodiments the horticulture lighting apparatus may comprise (i) a first set of one or more light sources, especially solid state light sources, configured to provide light having a wavelength selected from the range of 700-800 nm, (ii) a second set of one or more light sources, especially solid state light sources, configured to provide light having a wavelength selected from the range of 640-700 nm, and may optionally comprise (iii) a third set of light sources, especially one or more solid state light sources, configured to provide light having a peak wavelength selected from the range of 400-500 nm. More types of light sources may also be available.

The term “lighting apparatus” may also refer to a plurality of (different) lighting apparatus. Two or more of these may together provide the horticulture light, such as the first horticulture light and/or optionally the second horticulture light.

Basically, the same embodiments as described in relation to the method may also apply to the (horticulture) lighting apparatus.

The lighting apparatus may especially be used in the herein described method and/or in the herein described horticulture lighting system.

In yet a further aspect, the invention also provides a horticulture arrangement for plants, the horticulture arrangement comprising a horticulture lighting system as defined herein; and a support for support of the plants.

In use, the arrangement may include a plant support with a plant, or a plant support with a seed, or a plant support with a seedling, etc. . . . Hence, in use the system (comprising the arrangement) may include a plant support with a plant, or a plant support with a seed, or a plant support with a seedling, etc. . . . The terms “support” or “plant support” may refer to one or more of (particulate) substrate, aqueous substrate (in hydroponics), soil, wire (for wire crops), etc., which can be used to grow plants in, on, or along, etc.

The control system of such horticulture arrangement may control one or more of temperature, humidity, irrigation, nutrient supply, light intensity of the horticulture light, air conditions including one or more of air temperature, air composition, air flow, etc. . . . Such horticulture system may be configured to control one or more of these conditions at different locations in the arrangement.

As can also be derived from the above, in specific embodiments the horticulture lighting system and/or the horticulture arrangement may further comprising a sensor, wherein the sensor is configured to monitor a parameter of a plant and/or other parameters, and to provide a corresponding sensor signal, and wherein the control system is configured to horticulture lighting system and/or the horticulture arrangement in dependence of such sensor signal.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. . . . Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The system, or apparatus, or device may execute an action in a “mode” or “operation mode” or “mode of operation”. Likewise, in a method an action or stage, or step may be executed in a “mode” or “operation mode” or “mode of operation”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depict embodiments of lighting schemes;

FIG. 2 schematically depicts an embodiment a lighting system;

FIGS. 3a-3d depict the spectral power distributions of DR (3a), B (3b), W (3c), and FR (3d);

FIGS. 4a-4b depict the spectral power distributions of a composition including deep red, white and far red (4a), and deep red and blue (4b), respectively.

The schematic drawings are not necessarily to scale.

### DETAILED DESCRIPTION OF THE EMBODIMENTS

In medicinal cannabis industry, it appears that flower bud's production requires a reduction of the photoperiod from about 18 h to about 12 h . Flowers are produced for several weeks (in the order of about 8 to 10 weeks) under a short photoperiod of light to induce the flowering. It surprisingly appeared that when a 24 h schedule is applied for e.g. one or two days (i.e. in the range of about 24-72 hours of horticulture light), this would significantly increase the dry matter %, and nutrient content (CBD or THC for example), without changing the fresh matter production. Hence, amongst others the invention may be a way of using a light scheduling scheme adapted to the increase of dry matter % of flower buds. This may further also reduce nitrate accumulated in the flower and increase the nutrient (secondary metabolites) of the flowers. Hence, in embodiments e.g. one or more sequences of 24 h or 48 h or 72 h of continuous light application during e.g. the 8 to 10 weeks last flowering stage of the plant.

Yet further, it also surprisingly appeared that e.g. about 24 h to 48 h continuous light application before entering the flowering stage can be used to accelerate the flowering production under change of photoperiod from the vegetative stage to the flowering stage.

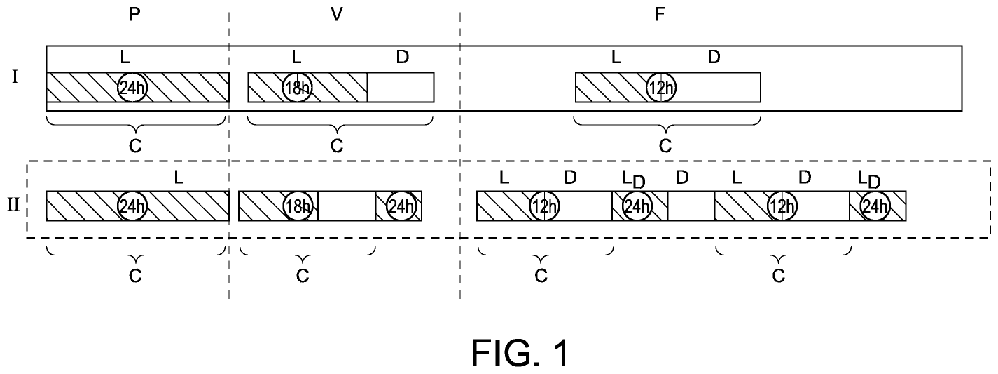

In FIG. 1 a standard scheme and modified schemes are schematically depicted; the drawing is not to scale. The upper time scheme, indicated with I, and the lower time scheme II, both comprise a sequence of a propagation stage P, a vegetative stage V, and a flowering stage F. The vegetative stage V may e.g. last about 2 weeks (nᵥ is about 2); the flowering stage F may e.g. last about 8-10 weeks (n_{f} is 8-10). The propagation stage P may e.g. be chosen to be about 2 weeks. The fluences may in embodiments be chosen to be e.g. about 100 μmol/m²/s for the propagation stage P, e.g. in the range of about 300-400 μmol/m²/s in the vegetative stage V, and e.g. about 500-1000 μmol/m²/s in the flowering stage F.

The schemes are not to scale.

In the upper scheme I and lower scheme II, in the propagation stage a full-time horticulture lighting is applied, i.e. the 24 h cycle C implies 24 hours horticulture lighting.

In the upper scheme I in the vegetative stage, a 24 h cycle C of e.g. 18 hours horticulture lighting L (regular on-time) and e.g. about 6 hours darkness D (regular off-time). The entire vegetative stage V, these cycles C may be repeated.

When the flowering stage is to be commenced, the horticulture lighting regime is changed to e.g. cycles C of about 12 hours horticulture light L (regular on-time) and about 12 hours darkness D (regular off-time). The entire flowering stage F, these cycles C may be repeated.

Such horticulture lighting scheme I may provide good growth results with good buds and flowers. However, it appears that with one or more deviations, especially in at least the flowering stage F, the dry matter weight percentage may substantially be increased. Hence, amongst others the invention provides intermittent continuous light application for the increase of dry matter percentage in flower buds of the Cannabis plant. The intermittent continuous light may comprise one or more pulses of at least 24 hours on-time, such as in the range of 24-72 hours on-time, like 24, 48, or 72 hours (though other values may also be possible) wherein the horticulture light is provided (especially according to the herein described fluences and/or spectral power distributions).

In the lower scheme II, in the flowering stage F again a plurality of above indicated cycles for the flowering stage may be executed (only a few are shown). However, one or more deviations of horticulture lighting periods, indicated with reference L_{D} (flowering stage deviation on-time), may be included. Here, by way of example two of such deviating pulses are shown, which, by way of example include an on-time of 24 hours. However, this may be longer, such as up to about 72 hours.

Hence, for both time scheme applies that the flowering stage time scheme lasts n_{f} weeks and includes a flowering stage on-off schedule of the horticulture light wherein during each 24 hours the on-time is at least 10 hours and the off-time is at least 10 hours. However, for the lower time scheme II, this flowering on-off schedule applies except for k_{f} deviations from the flowering stage on-off schedule of the flowering stage time scheme, wherein each deviation includes an on-time selected from the range of 24-72 hours, wherein n_{f} is at least 6, and wherein k_{f} is selected from the range of 1≤k_{f}≤n_{f}.

However, it also appears that with one or more deviations in the vegetative stage V, the transition from the vegetative stage to the flowering stage may be faster. In the lower scheme II, in the vegetative stage V again a plurality of above indicated cycles for the vegetative stage may be executed (only one is shown in this schematical drawing). However, one or more deviations of horticulture lighting periods, indicated with reference L_{D} (here (vegetative stage deviation on-time), may be included. Here, by way of example one of such deviating pulses is shown, which, by way of example, includes an on-time of 24 hours. However, this may be longer, such as up to about 72 hours. Especially, such pulse may be provided at the end of the vegetative stage V.

Further, the deviation pulse, especially a last deviation pulse, during or at the end of the vegetative stage may have a change in far red content, from relatively low at a first part of the 24-72 pulse to a higher far red content and/or a higher blue content (than during the regular on-time). The blue content may e.g. be at least 50%.

Hence, the horticulture light during a first part of a deviation on-time according to a deviation from the vegetative stage on-off schedule of the vegetative stage time scheme has an initial vegetative stage deviation pulse spectral power composition, and wherein the horticulture light during a second part of the deviation on-time according to the deviation from the vegetative stage on-off schedule of the vegetative stage time scheme has a final vegetative stage deviation pulse spectral power composition with an increased far red content relative to the first part, wherein the first part of each on-time is at least 8 hours, and wherein the second part of each on-time is at least 0.5 hours, such as at least 1 hour.

Hence, for both schemes I and II apply that horticulture light is provided to the Cannabis plant during the vegetative stage according to a vegetative stage time scheme, wherein the vegetative stage time scheme lasts nᵥ weeks and comprises a vegetative stage on-off schedule of the horticulture light wherein during each 24 hours the on-time is at least 16 hours and the off-time is at least 4 hours, and wherein nᵥ is at least 1. However, for the lower time scheme II, the vegetative stage on-off schedule applies except for kᵥ deviations from the vegetative stage on-off schedule of the vegetative stage time scheme, wherein each deviation includes an on-time selected from the range of 24-72 hours, and wherein kᵥ is selected from the range of 0≤kᵥ≤nᵥ (in fact here 1≤kᵥ≤nᵥ.).

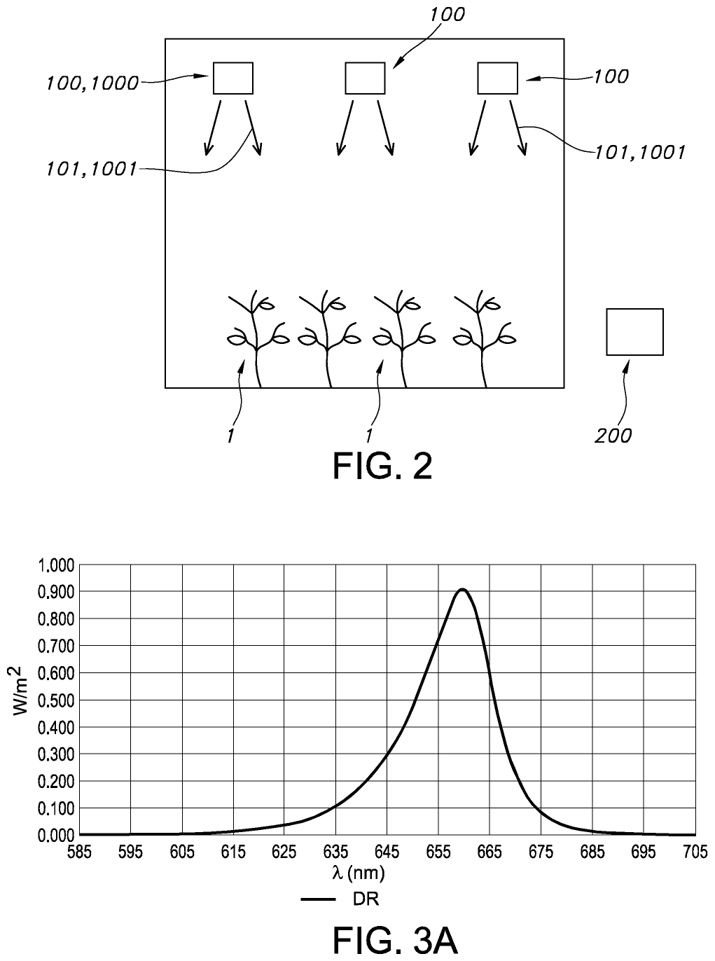

FIG. 2 schematically depicts an embodiment of a horticulture lighting system 1000. The lighting system comprises a lighting apparatus 100 configured to provide horticulture light 101 and a control system 200. The control system 200 may especially be configured to control the lighting apparatus 100 to provide during a controlling mode horticulture light 101 according to embodiments of the methods as defined herein. Horticulture light 101 may be provided by one or more lighting apparatus. Together they may provide lighting system light 1001 which comprises horticulture light 101 of one or more different lighting apparatus. Cannabis plants are indicated with reference.

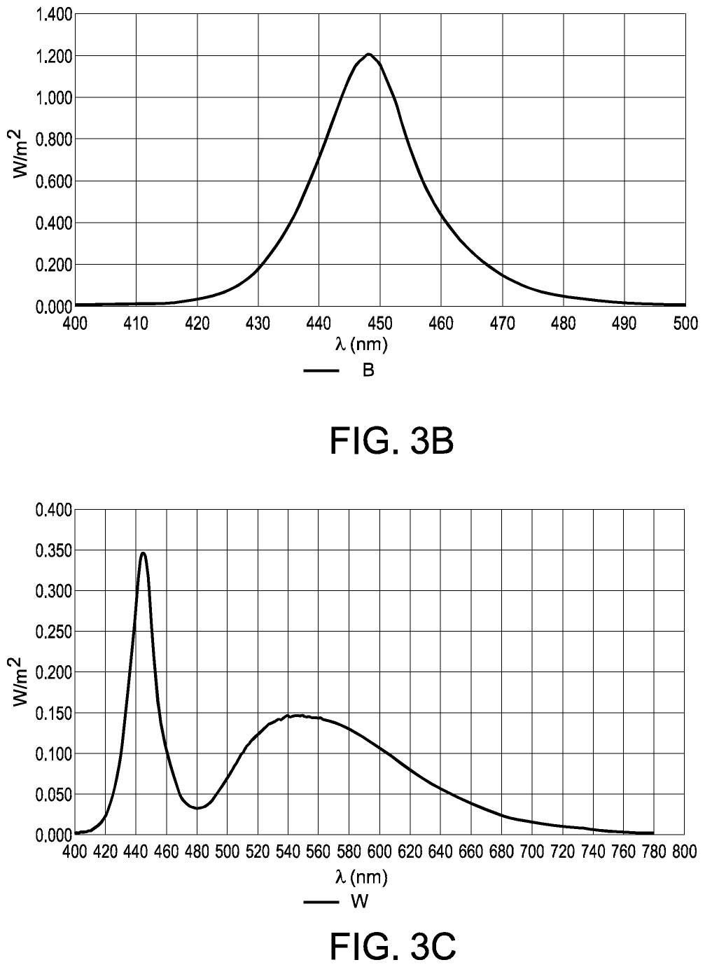

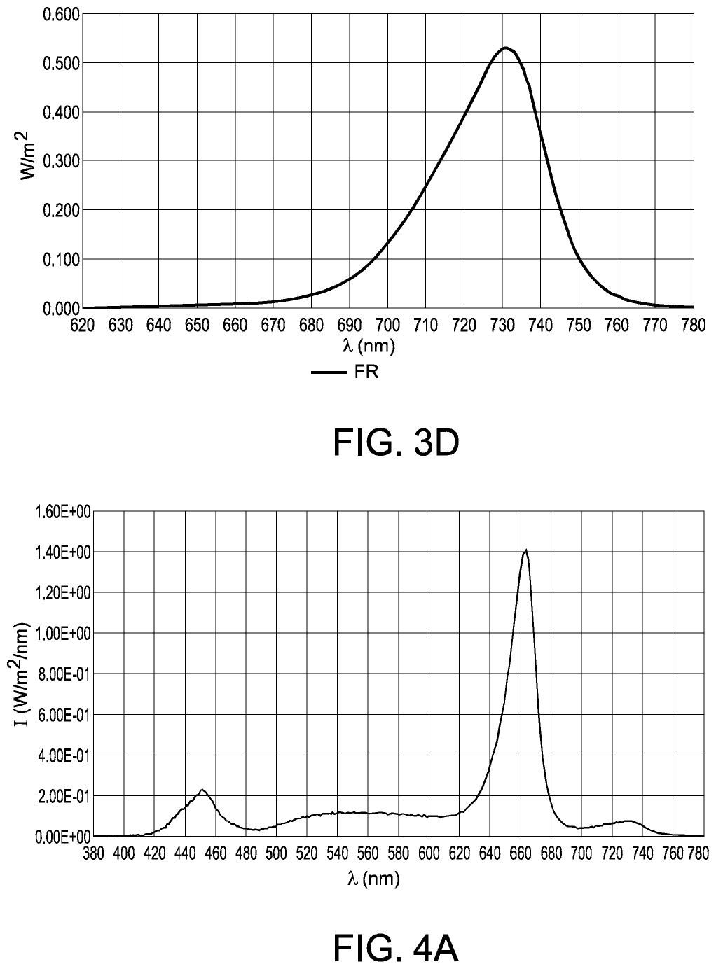

FIGS. 3a-3d shows the spectral power distributions of the different types of light that may be used as basis for creating the horticulture light. FIGS. 3a-3d depict the spectral power distributions of deep red DR (FIG. 3a), blue B (FIG. 3b), white W (FIG. 3c), and far red FR (FIG. 3d). Note that white light is in fact used as green component. In table 1a, the green component is indicated, with blue including both the blue component of white (W) and the blue component of blue (B). In table 1b, the intensities are indicated per spectral range. Of course, also a pure green emitter, being one or more LEDs or luminescent based light sources may be used for green light. On the y-axis of these Figures, the power is indicated as W/m², on the x-axis the wavelength in nm. The indication DR indicates deep red; the indication B indicates blue; the indication W indicates white; the indication FR indicates far red.

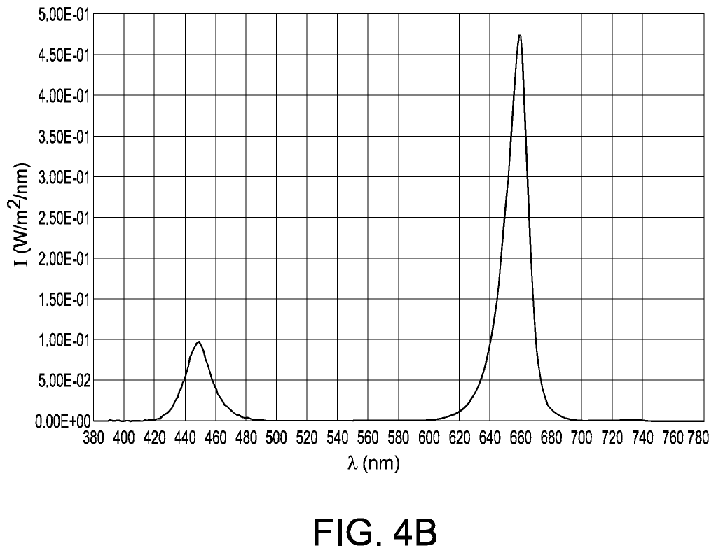

FIGS. 4a-4b depict the spectral power distributions of a composition including deep red, white and far red (4a), and deep red and blue (4b), respectively. The composition of FIG. 4a may e.g. be used for horticulture lighting of the cannabis plant.; the composition of FIG. 4b may also be used for horticulture lighting of the cannabis plant, especially during a deviation on-time during the flowering stage or the vegetative stage, or both.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” includes also embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A lighting method for providing light to a Cannabis plant during at least a flowering stage of the Cannabis plant, the method comprising: providing the horticulture light to the Cannabis plant during the flowering stage according to a flowering stage time scheme, wherein the flowering stage time scheme lasts n_{f} weeks and includes a flowering stage on-off schedule of the horticulture light wherein during each 24 hours the on-time is at least 10 hours and the off-time is at least 10 hours, except for k_{f} deviations from the flowering stage on-off schedule of the flowering stage time scheme, wherein each deviation includes an on-time selected from the range of 24-72 hours, wherein n_{f} is at least 6, and wherein k_{f} is selected from the range of 1≤k_{f}≤n_{f}, and
wherein the flowering stage time scheme lasts at least two weeks before a first of the k_{f} deviations from the flowering stage on-off schedule of the flowering stage time scheme takes place.

2. The lighting method according to claim 1, wherein the horticulture light during the on-time of the flowering stage on-off schedule and during the on-time of the k_{f} deviations is provided with a photosynthetic photon flux density selected from the range of 400-1200 μmol/m²/sec.

3. The lighting method according to claim 2, wherein n_{f} is at least 8, and wherein the flowering stage time scheme lasts at least six weeks before a first of the k_{f} deviations from the flowering stage on-off schedule of the flowering stage time scheme takes place.

4. The lighting method according to claim 1, further comprising providing light to a Cannabis plant during a vegetative stage of the Cannabis plant, the method comprising: providing horticulture light to the Cannabis plant during the vegetative stage according to a vegetative stage time scheme, wherein the vegetative stage time scheme lasts nᵥ weeks and comprises a vegetative stage on-off schedule of the horticulture light wherein during each 24 hours the on-time is at least 16 hours and the off-time is at least 4 hours, except for kᵥ deviations from the vegetative stage on-off schedule of the vegetative stage time scheme, wherein each deviation includes an on-time selected from the range of 24-72 hours, wherein nᵥ is at least 1, and wherein kᵥ is selected from the range of 0≤kᵥ<nᵥ.

5. The lighting method according to claim 4, wherein the horticulture light during the on-time during the vegetative stage time scheme has a vegetative stage light spectral power composition; and wherein the horticulture light during the on-time during the flowering stage time scheme has a flowering stage light spectral power composition wherein a far red content in the vegetative stage light spectral power composition is lower than in the flowering stage light spectral power composition.

6. The lighting method according to claim 4, wherein kᵥ≥1, wherein the lighting method comprises: providing the kᵥ deviations from the vegetative stage on-off schedule of the vegetative stage time scheme during a time period of the last three days of the vegetative stage time scheme preceding the flowering stage time scheme.

7. The lighting method according to claim 6, comprising: commencing the flowering stage time scheme subsequent to a deviation from the vegetative stage on-off schedule of the vegetative stage time scheme.

8. The lighting method according to claim 4, wherein during each 24 hours of the vegetative stage on-off schedule of the vegetative stage time scheme the on-time is at least 17 hours and the off-time is at least 5 hours, except for the kᵥ deviations from the vegetative stage on-off schedule of the vegetative stage time scheme, and wherein during each 24 hours of the flowering stage on-off schedule of the flowering stage time scheme the on-time is at least 11 hours and the off-time is at least 11 hours, except for the k_{f} deviations from the flowering stage on-off schedule of the flowering stage time scheme.

9. The lighting method according to claim 4 wherein the horticulture light during a first part of a deviation on-time according to a deviation from the vegetative stage on-off schedule of the vegetative stage time scheme has an initial vegetative stage deviation pulse spectral power composition, and wherein the horticulture light during a second part of the deviation on-time according to the deviation from the vegetative stage on-off schedule of the vegetative stage time scheme has a final vegetative stage deviation pulse spectral power composition with an increased far red content relative to the first part, wherein the first part of each on-time is at least 8 hours, and wherein the second part of each on-time is at least 0.5 hours.

10. The lighting method according to claim 4, further comprising a propagation lighting stage preceding the vegetative stage time scheme, wherein the propagation lighting stage comprises: providing horticulture light to the Cannabis plant according to a propagation stage time scheme, wherein the propagation stage time scheme lasts n3 weeks and comprises a propagation stage schedule of the horticulture light wherein during each 24 hours the on-time is selected from the range of 22-24 hours, wherein n3 is at least 1.

11. The lighting method according to claim 10, comprising:
providing the horticulture light during the on-time during the vegetative stage time scheme with a vegetative stage photosynthetic photon flux density selected from the range of 100-500 μmol/m²/sec; providing the horticulture light during the on-time during the flowering stage time scheme with a flowering stage photosynthetic photon flux density selected from the range of 400-1200 μmol/m²/sec, wherein the flowering stage photosynthetic photon flux density is larger than the vegetative stage photosynthetic photon flux density; and providing the horticulture light during the on-time during the propagation stage time scheme with a propagation stage photosynthetic photon flux density selected from the range of 70-150 μmol/m²/sec.

12. A method for growing a Cannabis plant for medicinal purposes, wherein the method comprises lighting the Cannabis plant according to the lighting method according to claim 1.

13. A non-transitory computer program product, when running on a computer which is functionally coupled to or comprised by a horticulture lighting system configured to generate in a controlling mode horticulture light as defined in claim 1, is capable of bringing about the method according to claim 1.

14. A horticulture lighting system, comprising:
a lighting apparatus configured to provide horticulture; and
a control system configured to control the lighting apparatus to provide during a controlling mode horticulture light according to the method of claim 1.

15. Use of k_{f} horticulture light pulses selected from the range of 24-72 hours during the flowering stage of a Cannabis plant, wherein the flowering stage lasts n_{f} weeks, wherein n_{f} is at least 6, and wherein k_{f} is selected from the range of 1≤k_{f}≤n_{f}, and
wherein the flowering stage lasts at least two weeks before a first of the k_{f} horticulture light pulse is used, and
wherein a photosynthetic photon flux density of the k_{f} horticulture light pulses and/or a duration of the k_{f} horticulture light pulses are selected to stress the Cannabis plant without damaging the Cannabis plant.
